(19) United States
(12) Patent Application Publication
(10) Pub. No.: US 2016/0048931 A1
(43) Pub. Date: Feb. 18, 2016

(54) System and Method for the Creation of DNA Guilds for Structuring Socially-, Legally- and Financially-Related Groups of Allelically or Phenotypically Related Individuals

(71) Applicants: Monir Mamoun, Morristown, NJ (US); Alicemarie Garin Rathjen, Sebastopol, CA (US)

(72) Inventors: Monir Mamoun, Morristown, NJ (US); Alicemarie Garin Rathjen, Sebastopol, CA (US)

(21) Appl. No.: 14/215,497

(22) Filed: Aug. 12, 2014

(51) Int. Cl. G06Q 50/00; G06Q 10/00

(52) U.S. Cl. CPC G06Q 50/01; G06Q 10/00

(57) ABSTRACT

The invention provides a method for the automated or semi-automated creation and management of human groups based on common genetic conditions, either real as confirmed by DNA or other genetic or hereditary assays, or hypothesized with respect to common phenotypic traits of group members. These groups, known individually as a “DNA Guild” and in plurality as “DNA Guilds,” are based on a customized triumvirate of social, legal and financial structural contracts which together comprise the individual operative charter for each DNA Guild. This novel structure solves the problem of how to form efficiently a plurality of distinct, special-purpose interest groups comprised of individuals or entities with interests related to specific genetic conditions, without the high overhead and risk of failure typically associated with founding traditional corporations, non-profit organizations, or other high-cost-overhead or loosely-structured groups.

### CROSS REFERENCE TO RELATED APPLICATIONS

This application claims priority benefit to USPTO provisional patent application No. 61/786,588, filed 15 Mar. 2013, System and Method for the Creation of DNA Guilds for Structuring Socially-, Legally- and Financially-Related Groups of Allelically or Phenotypically Related Individuals.

### BACKGROUND OF THE INVENTION

The fields of microbiology and bioinformatics have made tremendous gains in recent years. Techniques and technologies geared towards the detection, diagnosis, analysis and treatment of myriad genetic conditions have become widespread and are decreasing in cost quickly. The increasingly accessible nature of these technologies is rapidly creating a viable market for individuals to investigate their own genetic makeup. This cheaper, improved access to the genetic information encoded in each individual's DNA will spur a paradigm shift in how those individuals grapple with the challenges and potential for managing that information. This paradigm shift will occur as people figure out ways to optimize their health or that of their offspring, and seek out new ways to cure or manage long-term diseases and chronic conditions with a genetic basis.

One way this paradigm shift will manifest will be in the form of individuals creating groups focused on the research, cure or management of their known or hypothesized genetic conditions. As individuals learn more about their genetic makeup, they will tend to reach out to others who share, or may share, a common genetic link. They will seek to groups to share information, encourage research about their genetic condition, and to band together to encourage the cure or management of those conditions if they represent a hindrance to their lives.

### BRIEF SUMMARY OF THE INVENTION

A method is hereby described for the automated or semi-automated management of groups based on a common genetic conditions, either real as confirmed by DNA or other genetic or hereditary assays, or hypothesized (as may relate to as-yet-unexplained hereditary conditions or common phenotypic traits). These groups, known individually as a “DNA Guild” and in plurality as “DNA Guilds,” are based on a customized triumvirate of social, legal and financial structural contracts which together comprise the individual operative charter for each DNA Guild. This novel structure solves the problem of how to form efficiently a plurality of distinct, special-purpose interest groups comprised of individuals or entities with interests related to specific genetic conditions, without the high overhead and risk of failure typically associated with founding traditional corporations, non-profit organizations, or other high-cost-overhead or loosely-structured groups which may suffer from excessive formality or diffuse structure and focus, respectively. The DNA Guild formation process, in a preferred embodiment enabled by a web site, allows the rapid and efficient formation of highly structured groups by special interest groups in a fashion which was heretofore prohibitively expensive, risky or insufficiently structured without prohibitively high resource expenditure in money or labor.

### SUMMARY OF THE INVENTION

This method described relates to the formation of a “DNA Guild.” A DNA Guild is comprised of one of more individuals utilizing electronic media such as computers, mobile devices and the internet to spontaneously form a coherent, manageable structure organized around a limited, defined genetic (or suspected to be genetically-related) trait. DNA Guilds are formed for the purpose of facilitating a unified policy among guild members that governs guild membership, internal communications between guild members, as well as external policies that dictate how outsiders may relate to the group. A DNA Guild is characterized by the combination of three primary characteristics:

group communication and/or social networking mechanism, ranging the potential spectrum from complete isolation and anonymity of group members to fully publicized members rosters and open social networking

legal structure, ranging a potential spectrum from no specific legal structure to fully structured corporations, companies, ventures, or other entities which could enter binding contracts with external organizations on behalf of the DNA Guild members

financial structure, ranging a spectrum from no specific financial structure to any legally permissible financial arrangement including corporate financial structures, cost-sharing structures for members to share costs, or even revenue-sharing mechanisms for members to share profits

A DNA Guild is thus a facilitated entity, the creation of which is mediated via a semi-automated system such as a web site or similar networked multimedia system, formed in order to create a specifically designed combination of group communication mechanism, legal and financial structure with a unified group policy. As there are thousands of interesting human genetic conditions, and many different choices for how to specify the three legs (communication, legal and financial structures) of each DNA Guild, there is a need for a system to help automate the creation of many thousands of DNA Guilds to encompass the likely variety of ways in which people will seek to manage their relationship to their genetic condition (or conditions).

DNA Guilds will be created to enable, among other possibilities:

discussion groups

research groups

foster primary research

foster clinical trials

buying clubs

financial and legal remuneration for the participation of members in clinical or commercial ventures

One important way DNA Guilds will be used is in the management of group contracts. For example, people may wish to make themselves available for clinical trials. Normally assembling a group of clinical trial candidates is a very difficult and time consuming process involving the collection of numerous signed agreements and disclosures. DNA Guilds can streamline this process considerably; for example, a condition for membership in a guild may require members to assent to the automatic anonymous sharing of their genetic information with any research process agreed to by the majority of guild members. A simple affirmative vote by the majority may be all that is required, for example, to permit a researcher to use genetic data from the entire group; the full legal consent would already have been provided as a condition of guild membership; thus multiple research initiatives could be pursued and permitted by the group within the context of a very quick, cheap, efficient, lightweight process. This DNA Guild may have a social networking function designed to facilitate discussion and voting regarding which research processes to support; a legal function to facilitate the turning over of a group members' genetic data (or a limited subset of genetic data pertinent to a specific condition affecting those group members) to approved researchers; and a financial function designed to compensate the DNA Guild founder and/or members, according to a prescribed formula, should any remuneration be obtained from approved researchers.

Another possibility is that the DNA Guild may be formed with the express purpose of creating a “buying club” of members which a specific desire for a drug or treatment process. The guild may include a manager or managing group which is authorized to negotiate deals on behalf of the entire group, thereby giving members a powerful tool for more cost-effective treatment options and giving potential service providers ready access to a large, well-defined group of interested customers.

Each DNA Guild will be created by a founder, or one or plurality of founding entities, which could be a person, or one or a plurality of founding entities such as a group, company or even some kind of automated process such as a computer program. The founder may propose special powers (such as a limited legal power of attorney, or a right to claim special financial compensation for forming the DNA Guild should its operation later prove profitable); these powers will become binding with the formal legal consent of new members (or their legal guardians in the case of minors or incapacitated persons). The founder may also specify guidelines for DNA Guild membership, such as a permanently closed group, or an open group which may grow as people or other entities elect to join.

Numerous combinations and examples of DNA Guilds can be created. In a preferred embodiment, a DNA Guild may be formed with the primary intent of forming a drug buying club. Such a DNA Guild may essentially consist of 1) a social structure comprised of a private membership roster, 2) a legal structure in the form of a non-profit organization with the authority to negotiate group discounts with pharmaceutical companies, and 3) a financial structure that permits DNA Guild members to purchase drugs at a discount. In another preferred embodiment, a DNA Guild may be formed with the intent of offering pharmaceutical companies or academic research groups the ability to rapidly enlist its members as clinical trial subjects in exchange for receiving money. Such a DNA Guild may essentially consist of 1) a social structure comprised of a private membership roster, 2) a legal structure in the form of a for-profit LLC with the authority to negotiate for-pay compensation schemes with pharmaceutical companies or research groups that member may voluntarily participate in as they individually decide, and 3) a financial structure which distributes all net income to members depending on the individual participation of members in paid research. In another preferred embodiment, a DNA Guild may be formed with the intent to serve as a public membership group. In such a case, the DNA Guild may essentially consist of 1) a social structure with a public membership roster and open public discussions via internet forums, 2) a simple open legal structure in the form of an End-User License Agreement similar to that of many general social-networking sites, and 3) a financial structure consisting of various tiers of low-cost or free memberships according to the professional, student, or age status of members. In another preferred embodiment, a DNA Guild may exist to provide unpaid volunteers for clinical trials. In a such a case, the DNA Guild may have 1) a social structure comprised of a private membership roster and chat group, 2) a legal structure in the form of a non-profit that may sign research participation or material transfer agreements (MTAs) on behalf of its members' private DNA information, and 3) a financial structure in the form of a non-profit which may receive basic compensation from research groups or which may even sponsor certain clinical trials deemed of interest to the DNA Guild members.

1. Claimed is a system and method which allows for the facilitated creation of a plurality of groups known as “DNA Guilds,” each established according to a custom-selected triumvirate of primary governing structures comprising:
a governing structure for the communication or social networking mechanism to identify, link or anonymize group members, which is the first element of the triumvirate group structure known as the DNA Guild's “social structure”
a governing structure for the legal mechanism binding group members, which is the second element of the triumvirate group structure known as the DNA Guild's “legal structure”
a governing structure for the financial mechanism binding group members, which is the third element of the triumvirate group structure known as the DNA Guild's “financial structure”

2. The invention of claim 1 wherein the system, in a preferred embodiment an information technology service such as a web site, will present the founder or one or plurality of founding entities of each proposed DNA Guild with one or a plurality of choices for implementing each of the three components (communication/social, legal, financial) as well as the ability to customize wholly or in part any of these components.

3. The invention of claim 2 wherein the system, in a preferred embodiment an information technology service such as a web site, will permit members of the public, or individuals invited by the DNA Guild founder, or entities such as companies, universities, medical centers, patient groups, and research groups, or researchers, to join the DNA Guild in accordance with their agreement with the governing triumvirate rules of social, legal and financial structure created by the founder or one or plurality of founding entities

4. The invention of claim 2 wherein the founder or one or plurality of founding entities, or members of the DNA Guild, will have the ability to modify the governing social, legal or financial structures over time through fiat or vote-driven decision making mechanisms

5. The invention of claim 2 wherein the group shall be able to interact with other external entities such as companies, universities, research groups or political structures as a coherent social, legal and financial organization facilitated by the DNA Guilds technology, in a preferred embodiment of which is a web site or internet service that allows for such interaction as authorized by the DNA Guild triumvirate charter, or group vote, or automated mechanism preapproved as part of the group charter mechanism facilitated by the web site or internet service.

6. The invention of claim 2 wherein the triumvirate social, legal and financial combinations of DNA Guild structures allow associations of individuals to control the release of their genetic data and associated metadata, and the practice of how their genetic data and associated metadata is utilized.

7. The invention of claim 2 wherein the triumvirate social, legal and financial combinations of DNA Guild structures allow individual members of a DNA Guild to control the release of their genetic data and associated metadata, and the practice of how their genetic data and associated metadata is utilized.
